(19) United States
(12) Patent Application Publication
(10) Pub. No.: US 2019/0190284 A1
(43) Pub. Date: Jun. 20, 2019

(54) Open-Loop Limiting of a Charging Phase Pulsewidth

(71) Applicant: Qualcomm Incorporated, San Diego, CA (US)

(72) Inventors: Giuseppe Pinto, San Francisco, CA (US); Chunping Song, Sunnyvale, CA (US); Zhaohui Zhu, San Jose, CA (US); Christian Gregory Sporck, Campbell, CA (US)

(21) Appl. No.: 15/844,471

(22) Filed: Dec. 15, 2017

(51) Int. Cl. H02J 7/00; H02M 3/07

(52) U.S. Cl. CPC H02J 7/0029; H02J 7/0052; H02J 2007/0059; H02J 2007/0062; H02J 2007/0039; H02M 3/07

(57) ABSTRACT

An apparatus is disclosed for open-loop limiting of a charging phase pulsewidth. An example apparatus includes an input node, an output node coupled to a battery, a flying capacitor coupled to the output node, a driver circuit, a charging circuit, and an open-loop charging phase pulsewidth limiter coupled to the driver circuit and the charging circuit. The driver circuit generates a charging phase signal based on a clock signal. Using at least one switch that is coupled between the input node and the flying capacitor, the charging circuit connects or disconnects the flying capacitor to or from the input node based on the charging phase signal. The open-loop charging phase pulsewidth limiter monitors for at least one limit event associated with charging the battery with the flying capacitor. Responsive to detection of the limit event, the open-loop charging phase pulsewidth limiter limits a pulsewidth of the charging phase signal.

### TECHNICAL FIELD

This disclosure relates generally to battery charging and, more specifically, to open-loop limiting of a charging phase pulsewidth via a charge pump to provide protection during battery charging.

### BACKGROUND

Batteries are reliable, portable energy sources that are used by a wide range of electronic devices including mobile phones, laptops, toys, power tools, medical device implants, electronic vehicles, and satellites. A battery, however, stores a fixed amount of charge that is depleted during mobile operation of the electronic device. Instead of requiring the purchase of a replacement, many batteries are rechargeable via another power source. In this way, the same battery can be used multiple times.

With some battery recharging scenarios, an electronic device can be operated during the charging process. For example, a user may recharge a battery on a mobile phone while using the mobile phone to make a phone call, watch a movie, play a game, or search the Internet. These operations, however, can affect the battery charging process by causing current or voltage fluctuations. Left unchecked, these fluctuations can cause hazardous situations that may damage the battery, the electronic device, or the charging equipment. In some cases, fires may erupt that can injure users or damage property.

### SUMMARY

An apparatus is disclosed that implements open-loop limiting of a charging phase pulsewidth. Limiting the charging phase pulsewidth provides protection during the battery charging process by preventing hazardous situations from occurring. Furthermore, open-loop limiting of the charging phase pulsewidth can be implemented by a charge pump, thereby providing a fast response to load transients without external components, such as a low dropout (LDO) regulator.

In an example aspect, an apparatus is disclosed. The apparatus includes an input node, an output node coupled to a battery, a flying capacitor coupled to the output node, a driver circuit, a charging circuit, and an open-loop charging phase pulsewidth limiter that is coupled to the driver circuit and the charging circuit. The driver circuit is configured to generate a charging phase signal based on a clock signal, with the charging phase signal having a pulsewidth. The charging circuit has at least one switch that is coupled between the input node and the flying capacitor. Using the at least one switch, the charging circuit is configured to connect or disconnect the flying capacitor to or from the input node based on the charging phase signal. The open-loop charging phase pulsewidth limiter is configured to monitor for at least one limit event associated with charging the battery with the flying capacitor. Responsive to the detection of the at least one limit event, the open-loop charging phase pulsewidth limiter is configured to limit the pulsewidth of the charging phase signal to decrease a time period the flying capacitor is connected to the input node.

In an example aspect, an apparatus is disclosed. The apparatus includes an input node, an output node coupled to a battery, a flying capacitor coupled to the output node, a driver circuit, and a charging circuit. The driver circuit is configured to generate a charging phase signal based on a clock signal, with the charging phase signal having a pulsewidth. The charging circuit has at least one switch that is coupled between the input node and a flying capacitor. Using the at least one switch, the charging circuit is configured to connect or disconnect the flying capacitor to or from the input node based on the charging phase signal. The apparatus also includes monitor means for detecting at least one limit event associated with charging the battery using the flying capacitor. The apparatus further includes limit means for limiting the pulsewidth of the charging phase signal to decrease a time period the flying capacitor is connected to the input node. The limit means is coupled to the driver circuit and the charging circuit.

In an example aspect, a method for open-loop limiting of a charging phase pulsewidth is disclosed. The method includes generating, based on a clock signal, a charging phase signal that controls charging of a flying capacitor. The method also includes monitoring to detect at least one limit event associated with charging a battery with the flying capacitor. Responsive to detection of the at least one limit event, the method further includes limiting a pulsewidth of the charging phase signal to prevent charging of the flying capacitor for an occurrence of the at least one limit event.

In an example aspect, an apparatus is disclosed. The apparatus includes a battery and a charge pump. The charge pump includes an input node, an output node, a switch, and a flying capacitor. The output node is coupled between the flying capacitor and the battery. The switch is coupled between the input node and the flying capacitor. The charge pump is configured to generate, based on a clock signal, a charging phase signal to control opening and closing of the switch, with the charging phase signal having a pulsewidth that sets a time period for closing the switch. The charge pump is also configured to monitor the input node and the output node for at least one limit event that is associated with charging the battery with the flying capacitor. Responsive to detection of the at least one limit event, the charge pump is further configured to limit the pulsewidth of the charging phase signal to cause the charging phase signal to close the switch for the at least one limit event.

### BRIEF DESCRIPTION OF DRAWINGS

FIG. 1 illustrates an example environment for open-loop limiting of a charging phase pulsewidth.

FIG. 2 illustrates an example battery charging system for open-loop limiting of a charging phase pulsewidth.

FIG. 3 illustrates an example charge pump for open-loop limiting of a charging phase pulsewidth.

FIG. 4 illustrates an example implementation with a combined charging circuit and discharging circuit for open-loop limiting of a charging phase pulsewidth.

FIG. 5 illustrates an example open-loop charging phase pulsewidth limiter for open-loop limiting of a charging phase pulsewidth.

FIG. 6 illustrates an example driver circuit and limiter circuit for open-loop limiting of a charging phase.

FIG. 7 illustrates example signal responses associated with open-loop limiting of a charging phase pulsewidth.

FIG. 8 is a flow diagram illustrating an example process for open-loop limiting of a charging phase pulsewidth.

### DETAILED DESCRIPTION

Battery recharging is beneficial for extending use of a battery and saving costs associated with buying a replacement. During the charging process, it is important to control current and voltage to protect the battery, the electronic device, and the charging equipment. Such protection can also prevent hazardous situations from occurring. Some battery charging protection techniques use a linear regulator, such as a low-dropout (LDO) regulator, to regulate a current or a voltage. However, the low-dropout regulator increases both the cost and size of a battery charging system. Other techniques use a closed-loop regulation process that performs pulsewidth modulation to set a value of the current or the voltage based on a reference value. The pulsewidth modulation enables the closed-loop regulation process to increase or decrease the current or the voltage to achieve a desired operating point.

In contrast, example approaches are described herein for open-loop limiting of a charging phase pulsewidth. Limiting the charging phase pulsewidth provides protection during the battery charging process, thereby preventing hazardous situations from occurring. The open-loop limiting aspect differs from the closed-loop regulation techniques by constraining a current or a voltage when a limit event occurs, such as the current or the voltage exceeding a threshold. Instead of actively controlling a value of the current or the voltage, the open-loop limiting of the charging phase pulsewidth enables the current or the voltage to realize any value below an upper limit. In addition, the open-loop aspect enables a faster response to load transients as compared to closed-loop techniques because limiting the charging phase pulsewidth does not include additional steps associated with determining a desired pulsewidth modulation that enables the reference value to be realized. Open-loop limiting of the charging phase pulsewidth can also be implemented by a charge pump, thereby providing protection without additional components, such as a low dropout (LDO) regulator.

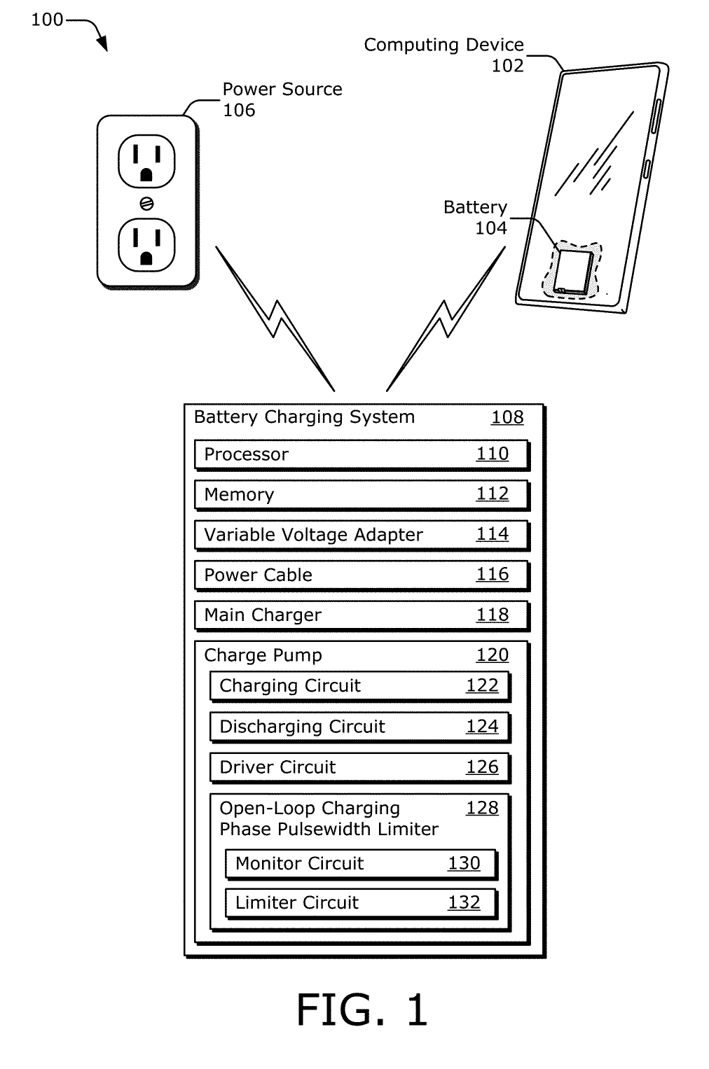

FIG. 1 illustrates an example environment 100 for open-loop limiting of a charging phase pulsewidth. In the example environment 100, a computing device 102 includes a battery 104 that can be charged using a power source 106 and a battery charging system 108. In this example, the computing device 102 is implemented as a smart phone. However, the computing device 102 may be implemented as any suitable computing or electronic device, such as a cellular phone, gaming device, navigation device, laptop computer, desktop computer, tablet computer, smart appliance, vehicle, medical device, satellite, and so forth. The battery 104 can include a variety of types, including lithium-ion, lithium polymer, nickel-metal hydride, nickel-cadmium, lead acid, and so forth. Although depicted as an electrical outlet, the power source 106 can represent any type of power source, including a solar charger, a portable charging station, a wireless charger, another battery, and so forth. The battery 104 can have a maximum voltage rating that characterizes a limit to an amount of voltage the battery 104 can safely handle. For example, a maximum voltage rating for the battery 104 may be approximately 4.5 volts (V).

The battery charging system 108 is coupled between the power source 106 and the battery 104. As shown, the battery charging system includes a processor 110 and memory 112. The processor 110 may include any type of processor, such as a single-core processor or a multi-core processor, that executes processor-executable code stored by the memory 112. The memory 112 may include any suitable type of data storage media, such as volatile memory (e.g., random access memory (RAM)), non-volatile memory (e.g., Flash memory), optical media, magnetic media (e.g., disk or tape), and so forth. In the context of this disclosure, the memory 112 is implemented to store instructions, data, and other information of the battery charging system 108, and thus does not include transitory propagating signals or carrier waves.

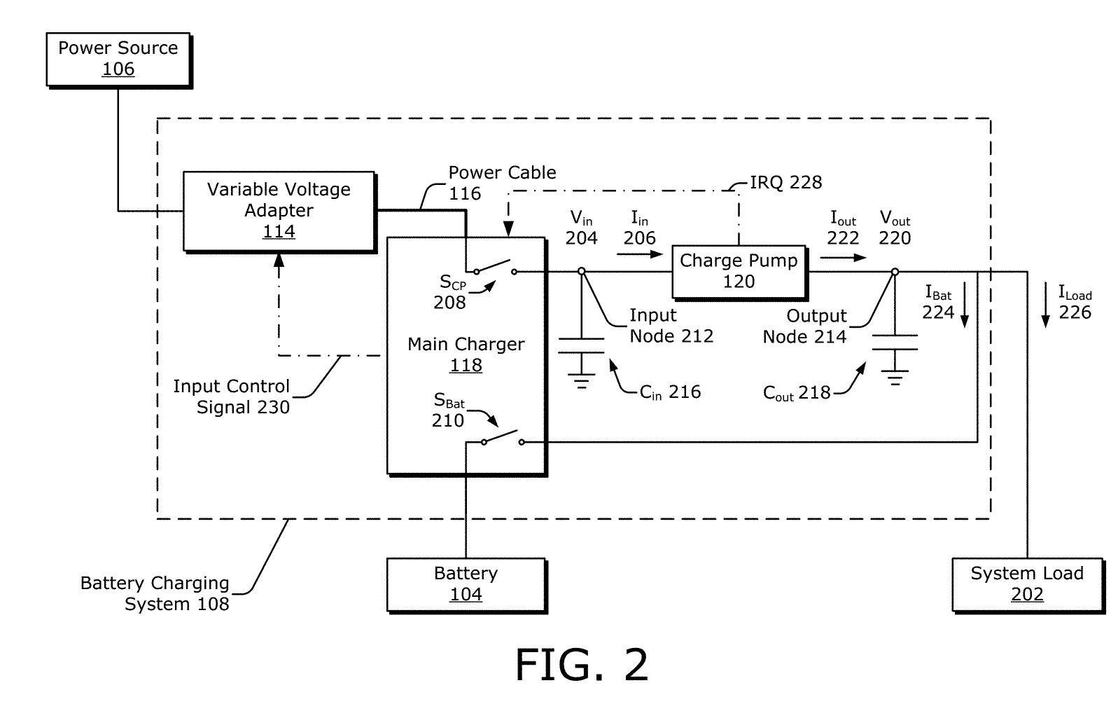

As illustrated, the battery charging system 108 also includes a variable voltage adapter 114, a power cable 116, a main charger 118, and a charge pump 120. In general, the battery charging system 108 charges the battery 104 via the main charger 118 or the charge pump 120. The charge pump 120 includes a charging circuit 122, a discharging circuit 124, a driver circuit 126, and an open-loop charging phase pulsewidth limiter 128. The open-loop charging phase pulsewidth limiter 128 includes a monitor circuit 130 and a limiter circuit 132. Components of the battery charging system 108 can be distributed such that some are external to the computing device 102 (e.g., the variable voltage adapter 114 and the power cable 116) while others are integrated within the computing device 102 (e.g., the main charger 118 and the charge pump 120). In other implementations, the components of the battery charging system 108 may be distributed in different manners. Additionally, the processor 110 and the memory 112 may be implemented within the main charger 118. The components of the battery charging system 108 are further described with respect to FIG. 2.

FIG. 2 illustrates an example battery charging system 108 for open-loop limiting of a charging phase pulsewidth. The battery charging system 108 is coupled between the power source 106, the battery 104, and a system load 202. This configuration enables the computing device 102, represented by the system load 202, to receive power for performing operations while the battery charging system 108 charges the battery 104. These operations, however, can cause load transients to occur, which result in current or voltage fluctuations during the battery charging process. Example operations can range from user-initiated actions, such as a user making a phone call or opening an application, to device-initiated operations, such as the computing device 102 performing an automatic software update or scanning for computer viruses. These fluctuations can cause hazardous situations that may damage the battery 104, the computing device 102, or the battery charging system 108.

In the depicted configuration, the variable voltage adapter 114 is coupled to the power source 106. The variable voltage adapter 114 can be implemented using, for example, a variable input voltage wall adapter that is configured to plug into a wall socket. In general, the variable voltage adapter 114 converts a voltage provided by the power source 106 and generates an input voltage 204 (Vᵢₙ 204). The variable voltage adapter 114, for example, can convert alternating current (AC) to direct current (DC) and generate the input voltage 204 that is desirable for the main charger 118 or the charge pump 120. A range of different voltages can be provided by the variable voltage adapter 114, such as a range of approximately 3 V to 12 V for many portable, hand-held devices. The variable voltage adapter 114 is coupled to the power cable 116, which carries an input current 206 (Iᵢₙ 206) from the variable voltage adapter 114 to the main charger 118 or the charge pump 120. The power cable 116 can have a maximum current rating that characterizes a limit for an amount of current the power cable 116 can safely carry. For example, a maximum current that the power cable 116 can safely carry may be approximately three amperes (A).

The main charger 118 is coupled to the power cable 116 and includes a charge pump switch (S_{CP}) 208 and a battery switch (S_{Bat}) 210. The charge pump switch 208 and the battery switch 210 connect or disconnect the charge pump to or from the variable voltage adapter 114 and the battery 104, respectively. The charge pump switch 208 and the battery switch 210 can be implemented using, for instance, transistors. Through the charge pump switch 208 and the battery switch 210, the main charger 118 can control whether the charge pump 120 or the main charger 118 charges the battery 104. When the charge pump 120 is disconnected from the variable voltage adapter 114 and the battery 104, the main charger 118 charges the battery 104 using a power path that is in parallel with the charge pump 120 (not depicted). The main charger 118 can also include watchdog timers, temperature sensors, and other sensors to monitor performance of the battery charging system 108.

The main charger 118 generates an input control signal 230 for controlling the variable voltage adapter 114. The input control signal 230 can be generated using, for example, the processor 110 and the memory 112. The input control signal 230 sets the input voltage 204 that is produced by the variable voltage adapter 114. The input voltage 204 can be set, for example, to twice a voltage of the battery 104. The main charger 118 can include, for instance, a universal serial bus (USB) physical layer to communicate the input control signal 230 over a USB interface to the variable voltage adapter 114. In general, a delay is associated with adjusting the input voltage 204 via the input control signal 230. This delay can be, for example, on the order of approximately 20 milliseconds (ms) or more. Due to this delay, the main charger 118 may not be able to adjust the input voltage 204 quickly enough to provide protection during battery charging.

In situations in which a voltage across the battery 104 is too low (e.g., the battery 104 is significantly depleted), the main charger 118 initially charges the battery 104. During normal operation, such as when the voltage of the battery 104 is sufficient to enable the processor 110 to execute software that generates the input control signal 230, the main charger 118 enables the charge pump 120 to charge the battery 104. Typically, operating efficiency of the charge pump 120 is higher than that of the main charger 118. As an example, the main charger 118 can be implemented using a buck converter that operates at approximately 90% efficiency whereas the charge pump 120 can operate at approximately 95% efficiency or higher.

At an input node 212, the charge pump 120 is coupled to the main charger 118 and the variable voltage adapter 114 (via the main charger 118). At an output node 214, the charge pump 120 is coupled to the system load 202, the main charger 118, and the battery 104 (via the main charger 118). In the depicted configuration, an input capacitor 216 (Cᵢₙ 216) and an output capacitor 218 (Cₒᵤₜ 218) are respectively coupled between a ground and the input node 212 and the output node 214.

The techniques for open-loop limiting of a charging phase pulsewidth can be implemented for a variety of charge pumps, including voltage dividers and voltage multipliers. In general, the charge pump 120 is implemented as an integrated circuit that operates as a switched mode power supply (SMPS). The charge pump 120 generates an output voltage 220 (Vₒᵤₜ 220) and an output current 222 (Iₒᵤₜ 222) based on the input voltage 204, the input current 206, and a conversion ratio. The conversion ratio can be fixed or variable. As an example, the charge pump 120 can be implemented as a voltage divider having a fixed conversion ratio of two-to-one, meaning the output voltage 220 is equal to approximately half of the input voltage 204 and the output current 222 is equal to approximately twice the input current 206. A portion of the output current 222 can be routed to the battery 104 via a battery current (I_{Bat}) 224 and another portion of the output current 222 can be routed to the system load 202 via a load current (I_{Load}) 226. To change the output voltage 220, the main charger 118 adjusts the input voltage 204 via the input control signal 230.

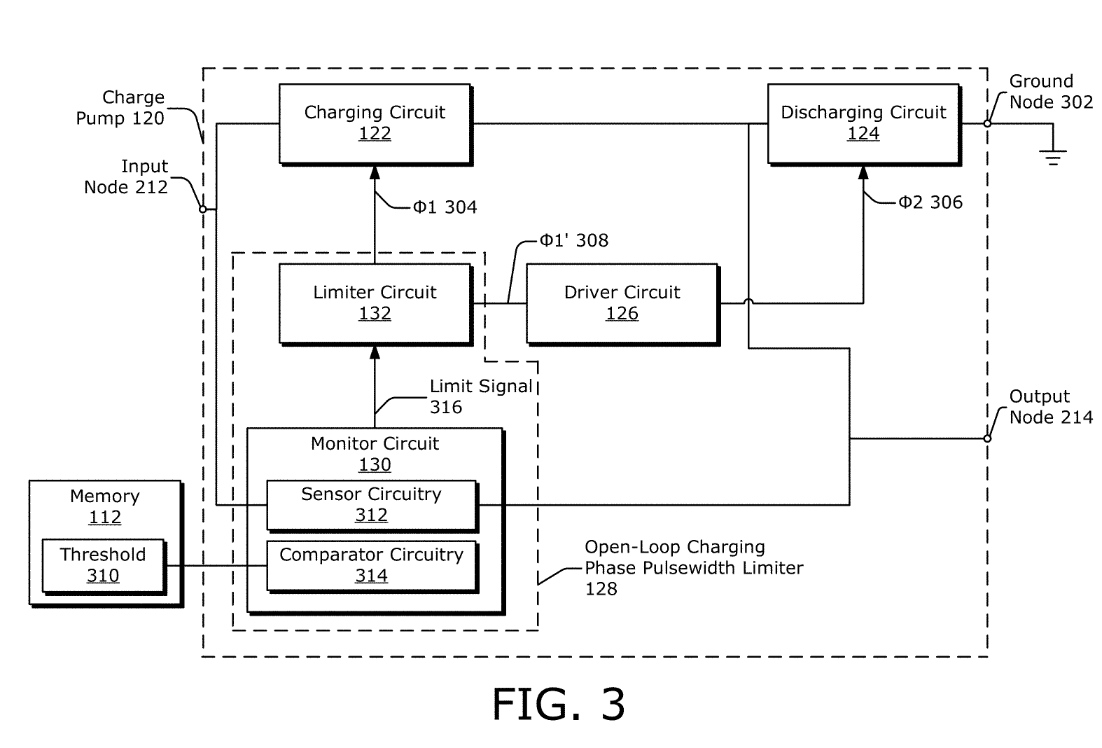

Load transients can cause sudden current or voltage variations in the battery charging system 108. Consider a smart phone being charged by the battery charging system 108. While the charge pump 120 charges the battery 104, a user may use the smart phone to make a phone call, which causes the system load 202 to suddenly change. This change causes the load current 226 to increase, and in response, the input current 206 increases. If left unchecked, an overcurrent situation can occur for which the input current 206 is higher than the maximum current rating of the power cable 116. Likewise, after the phone call is terminated, another change to the system load 202 causes the load current 226 to decrease and, in response, the output voltage 220 increases. Again, without a protective measure, an overvoltage situation can occur for which the output voltage 220 is higher than the maximum voltage rating of the battery 104. As described in further detail below, the charge pump 120 can detect signs leading up to these hazardous situations. In response, the charge pump 120 can send an interrupt request 228 (IRQ 228) to the main charger 118 to cause the main charger 118 to decrease the input voltage 204. However, due to the delay time associated with adjusting the input voltage 204 via the variable voltage adapter 114, the charge pump 120 implements open-loop limiting of a charging phase pulsewidth to prevent the hazardous situations from occurring, as described with reference to FIG. 3.

FIG. 3 illustrates an example charge pump 120 for open-loop limiting of a charging phase pulsewidth. The charge pump 120 includes the charging circuit 122 coupled to the input node 212 and the output node 214, and the discharging circuit 124 coupled to a ground node 302 and the output node 214. The charging circuit 122 and the discharging circuit 124 include switches (not shown in FIG. 3) that are respectively controlled via a charging phase signal 304 (φ1 304) and a discharging phase signal 306 (φ2 306). The charging phase signal 304 and the discharging phase signal 306 are generated by the open-loop charging phase pulsewidth limiter 128 and the driver circuit 126, respectively. The driver circuit 126 generates an intermediate charging phase signal (φ1′) 308 and the discharging phase signal 306 based on a clock signal (not shown in FIG. 3). The driver circuit 126 is coupled to the discharging circuit 124 to communicate the discharging phase signal 306. The driver circuit 126 is also coupled to the open-loop charging phase pulsewidth limiter 128 to communicate the intermediate charging phase signal 308.

The open-loop charging phase pulsewidth limiter 128 includes the monitor circuit 130 and the limiter circuit 132. The monitor circuit 130 includes sensor circuitry 312 and comparator circuitry 314. The sensor circuitry 312 includes at least one sensor, such as current sensor or a voltage sensor, to detect signs that warn of a potential hazardous situation. As shown in FIG. 3, the sensor circuitry 312 can be coupled to the input node 212 or the output node 214 to sense currents or voltages at these nodes. The comparator circuitry 314 includes at least one comparator to compare the current or voltage sensed by the sensor circuitry 312 to a threshold 310. The threshold 310 can be, for example, a programmable threshold that is stored in the memory 112 and written to a register (not explicitly shown) by the processor 110. The comparator circuitry 314 can read the register and generate a reference voltage that represents the threshold 310. In general, the threshold 310 is used by the monitor circuit 130 to activate protection measures performed by the limiter circuit 132.

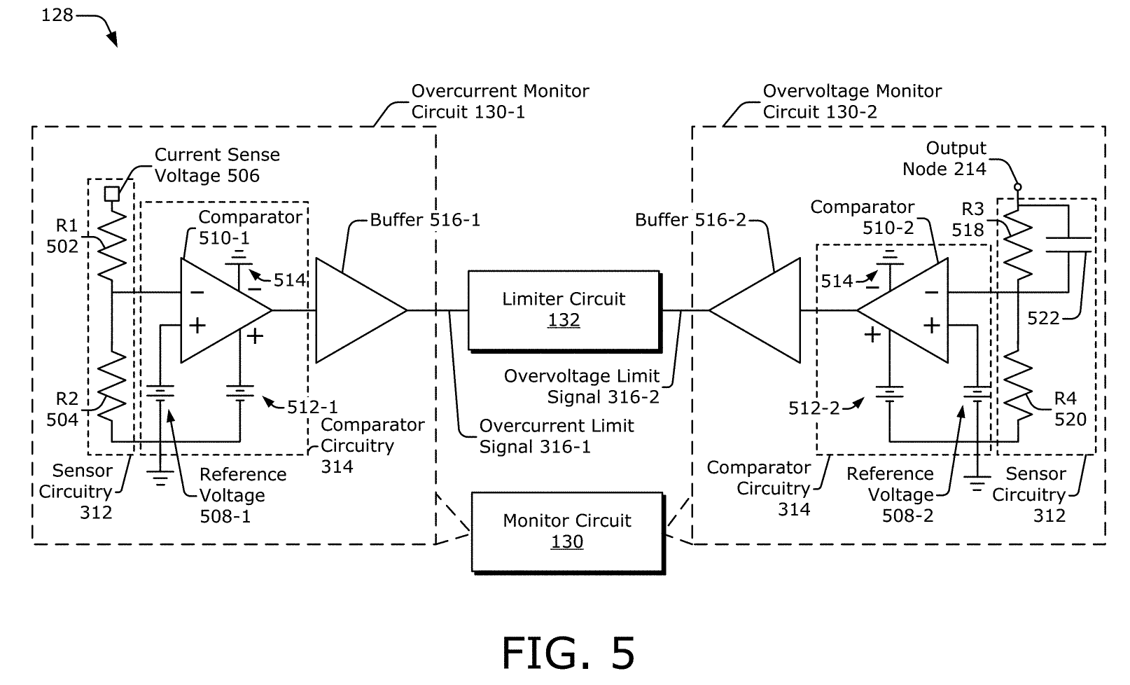

The monitor circuit 130 generates a limit signal 316 that indicates whether or not the comparator circuitry 314 determined the current or voltage sensed by the sensor circuitry 312 exceeds the corresponding threshold 310. Herein, the term “limit event” is used to describe a situation for which the current or voltage exceeds the corresponding threshold 310 and for which the monitor circuit 130 initiates limiting of a pulsewidth of the charging phase signal 304 via the limit signal 316. In general, the limit event is a precursor to a hazardous situation; therefore, detecting and responding to the limit event enables the hazardous situation to be prevented or avoided. In some implementations, the monitor circuit 130 can include multiple monitor circuits 130 and the limit signal 316 can include multiple limit signals 316, as described in further detail with respect to FIG. 5.

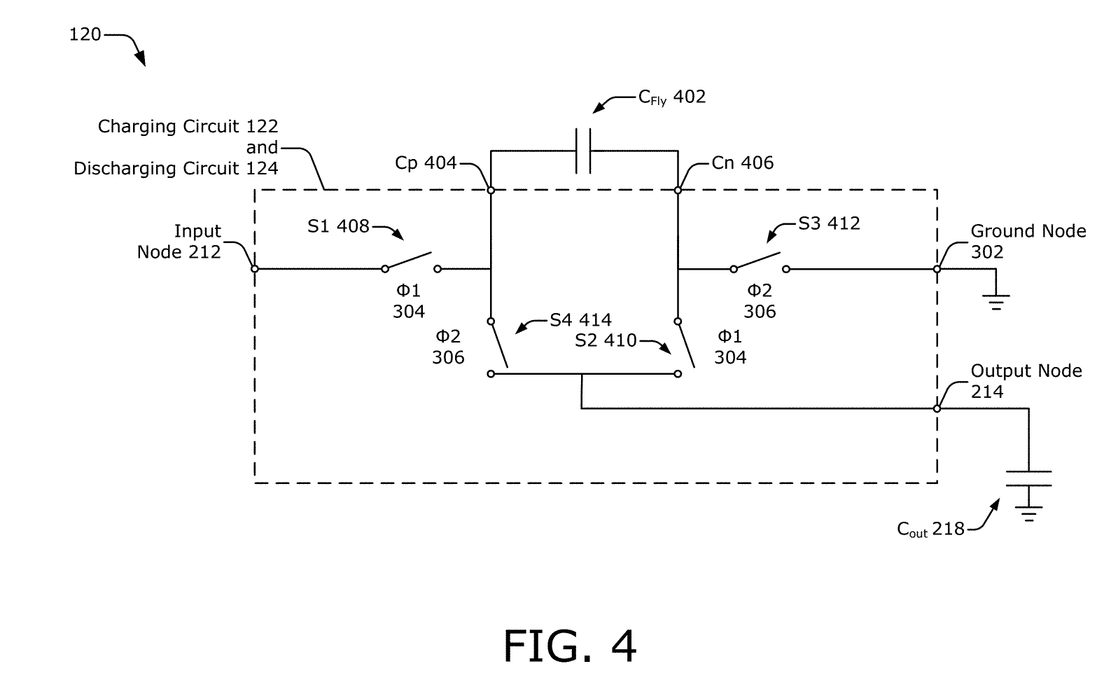

The limiter circuit 132 receives the limit signal 316 from the monitor circuit 130. Based on the limit signal 316, the limiter circuit 132 generates the charging phase signal 304. With respect to the intermediate charging phase signal 308, the limiter circuit 132 limits the pulsewidth of the charging phase signal 304 if the limit event is detected by the monitor circuit 130. In other words, the charging phase signal 304 can be gated or truncated by the limit signal 316. By limiting the pulsewidth, the limiter circuit 132 is able to reduce the current or the voltage. Although depicted separately, some implementations may integrate the limiter circuit 132 within the driver circuit 126. Examples of the charging circuit 122, the discharging circuit 124, the monitor circuit 130, the driver circuit 126, and the limiter circuit 132 are described in further detail with respect to FIGS. 4-6.

FIG. 4 illustrates an example implementation with a combined charging circuit 122 and discharging circuit 124 for open-loop limiting of a charging phase pulsewidth. The charge pump 120 includes a flying capacitor 402 (C_{Fly} 402) that is coupled to a positive node 404 (C_{P} 404) and a negative node 406 (C_{N} 406). Using the flying capacitor 402, the charging circuit 122 and the discharging circuit 124 implement a voltage divider-type charge pump 120 having, e.g., a fixed two-to-one conversion ratio. This type of charge pump 120 configuration generates the output current 222 to be approximately twice the input current 206 (both of FIG. 2). Therefore, less expensive power cables 116, which have a lower maximum current rating, may be used for charging the battery 104.

The charging circuit 122 includes at least one switch that couples the flying capacitor 402 to the input node 212, and the discharging circuit 124 includes at least one other switch that couples the flying capacitor 402 to a ground via the ground node 302. In the depicted configuration, the charging circuit 122 includes a first switch 408 (S1 408) coupled between the positive node 404 and the input node 212. The charging circuit 122 also includes a second switch 410 (S2 410) coupled between the negative node 406 and the output node 214. Operations (e.g., opening and closing) of the first switch 408 and the second switch 410 are controlled by the charging phase signal 304. Likewise, the discharging circuit 124 includes a third switch 412 (S3 412) coupled between the ground node 302 and the negative node 406. The discharging circuit 124 also includes a fourth switch 414 (S4 414) coupled between the positive node 404 and the output node 214. Operations of the third switch 412 and the fourth switch 414 are controlled by the discharging phase signal 306.

The switches 408 through 414 can be implemented using transistors, such as metal-oxide-semiconductor field-effect transistors (MOSFETs), junction field-effect transistors (JFETs), bipolar junction transistors (BJTs), insulated gate bipolar transistors (IGBTs), diodes, and so forth. For example, the first switch 408 can be implemented with an n-channel MOSFET having a drain coupled to the input node 212, a source coupled to the positive node 404, and a gate coupled to the limiter circuit 132 for receiving the charging phase signal 304. Likewise, the third switch 412 can be implemented using another n-channel MOSFET having a drain coupled to the negative node 406, a source coupled to the ground node 302, and a gate coupled to the driver circuit 126 to receive the discharging phase signal 306. The charging circuit 122 and the discharging circuit 124 are active when their respective switches are closed. Typically, the charging phase signal 304 and the discharging phase signal 306 are generated such that either the charging circuit 122, the discharging circuit 124, or neither are active. In other words, the charging circuit 122 and the discharging circuit 124 are generally not active at the same time.

When the charging phase signal 304 closes the first switch 408 and the second switch 410, the charging circuit 122 connects the flying capacitor 402 to the input node 212 via the positive node 404 to transfer charge from the power source 106 to the flying capacitor 402 (e.g., to increase a voltage across the flying capacitor 402). In other words, the charging circuit 122 charges the flying capacitor 402. The charging circuit 122 also connects the flying capacitor 402 in series with the output capacitor 218 (of FIG. 2), thereby causing the output voltage 220 to be approximately half the input voltage 204.

When the discharging phase signal 306 closes the third switch 412 and the fourth switch 414, the discharging circuit 124 connects the flying capacitor 402 to the ground via the ground node 302 to transfer charge from the flying capacitor 402 to the output capacitor 218, the battery 104, or the system load 202. In other words, the discharging circuit 124 connects the flying capacitor 402 in parallel with the output capacitor 218 to discharge the flying capacitor 402.

FIG. 5 illustrates an example open-loop charging phase pulsewidth limiter 128 for open-loop limiting of a charging phase pulsewidth. The open-loop charging phase pulsewidth limiter 128 includes the monitor circuit 130 and the limiter circuit 132. In the depicted configuration, the monitor circuit 130 is implemented via an overcurrent monitor circuit 130-1 and an overvoltage monitor circuit 130-2. Accordingly, the limit signal 316 can include an overcurrent limit signal 316-1 generated by the overcurrent monitor circuit 130-1 and an overvoltage limit signal 316-2 generated by the overvoltage monitor circuit 130-2. Although the monitor circuit 130 is shown as including the overcurrent monitor circuit 130-1 and the overvoltage monitor circuit 130-2, the techniques for implementing open-loop limiting of the charging phase pulsewidth can be applied to any type and number of monitoring circuits 130.

The overcurrent monitor circuit 130-1 includes the sensor circuitry 312, which is implemented using a first resistor 502 (R1 502) and a second resistor 504 (R2 504) coupled in series between a current sense voltage 506 and a ground. The sensor circuitry 312 also includes a current sensor (not shown) coupled to the input node 212 (e.g., of FIGS. 2-4). The current sensor measures the input current 206 and generates the current sense voltage 506, which is proportional to the input current 206 (e.g., the input current 206 is represented by the current sense voltage 506). In some cases, the current sense voltage 506 can represent an average input current 206. The first resistor 502 and the second resistor 504 scale the current sense voltage 506 for the comparator circuitry 314.

The comparator circuitry 314 includes a first comparator 510-1 having a positive input terminal, a negative input terminal, a positive-side power supply terminal, and a negative-side power supply terminal. In the depicted configuration, the first comparator 510-1 is an inverting comparator, having the negative input terminal coupled to a node that is in-between the first resistor 502 and the second resistor 504, and the positive input terminal coupled to the first reference voltage 508-1. The first reference voltage 508-1 is a programmable voltage that represents the threshold 310 (of FIG. 3). For the overcurrent monitor circuit 130-1, the first reference voltage 508-1 represents an input current threshold, which can be set based on the maximum current rating of the power cable 116. The positive-side power supply terminal is coupled to a first voltage supply 512-1 and the negative-side power supply terminal is coupled to a ground 514. The first voltage supply 512-1 and the ground 514 respectively set a high voltage level and a low voltage level of the overcurrent limit signal 316-1. The first comparator 510-1 can also be coupled to a first buffer 516-1, which passes the overcurrent limit signal 316-1 to the limiter circuit 132 and isolates the overcurrent monitor circuit 130-1 from the limiter circuit 132.

In general, the overcurrent monitor circuit 130-1 monitors the input current 206 and detects an overcurrent limit event. The overcurrent limit event represents a time during which the input current 206 exceeds the input current threshold. If the voltage at the negative input terminal of the first comparator 510-1 (e.g., the voltage that represents the input current 206) is lower than the first reference voltage 508-1 (e.g., the input current threshold), the overcurrent limit signal 316-1 is set to the first voltage supply 512-1 (e.g., a high voltage level) to indicate that the overcurrent limit event is not detected. In contrast, if the voltage at the negative input terminal is higher than the first reference voltage 508-1, the overcurrent limit signal 316-1 is set to the ground 514 (e.g., a low voltage level) to indicate that the overcurrent limit event is detected. In this way, the overcurrent monitor circuit 130-1 continually monitors the input current 206, detects whether the overcurrent limit event occurred, and generates the overcurrent limit signal 316-1 to indicate whether or not the overcurrent limit event is detected.

Similar to the overcurrent monitor circuit 130-1, the overvoltage monitor circuit 130-2 includes the sensor circuitry 312, which is implemented using a third resistor 518 (R3 518) and a fourth resistor 520 (R4 520) coupled in series between the output node 214 and a ground, and a capacitor 522 coupled in parallel with the third resistor 518. The sensor circuitry 312 can also be implemented using a voltage sensor coupled to the output node 214 (e.g., of FIGS. 2-4). The third resistor 518, the capacitor 522, and the fourth resistor 520 scale the output voltage 220 at the output node 214 for the comparator circuitry 314.

The comparator circuitry 314 includes a second comparator 510-2 having a positive input terminal, a negative input terminal, a positive-side power supply terminal, and a negative-side power supply terminal. In the depicted configuration, the second comparator 510-2 is an inverting comparator, having the negative input terminal coupled to a node between the third resistor 518 and the fourth resistor 520, and the positive input terminal coupled to the second reference voltage 508-2. The second reference voltage 508-2 is a programmable voltage that represents the threshold 310 (of FIG. 3). For the overvoltage monitor circuit 130-2, the second reference voltage 508-2 represents an output voltage threshold, which can be set based on the maximum voltage rating of the battery. The positive-side power supply terminal is coupled to a second voltage supply 512-2 and the negative-side power supply terminal is coupled to a ground 514. The second voltage supply 512-2 and the ground 514 respectively set a high voltage level and a low voltage level of the overvoltage limit signal 316-2. The second voltage supply 512-2 can be similar to or different than the first voltage supply 512-1. The second comparator 510-2 can also be coupled to a second buffer 516-2, which passes the overvoltage limit signal 316-2 to the limiter circuit 132 and isolates the overvoltage monitor circuit 130-2 from the limiter circuit 132.

In general, the overvoltage monitor circuit 130-2 monitors the output voltage 220 and detects an overvoltage limit event. The overvoltage limit event represents a time during which the output voltage 220 exceeds the output voltage threshold. If the voltage at the negative input terminal (e.g., the voltage that represents the output voltage 220) is lower than the second reference voltage 508-2 (e.g., lower than the output voltage threshold), the overvoltage limit signal 316-2 is set to the second voltage supply 512-2 (e.g., a high voltage level) to indicate that the overvoltage limit event is not detected. In contrast, if the voltage at the negative input terminal is higher than the first reference voltage 508-1, the overvoltage limit signal 316-2 is set to the ground 514 (e.g., a low voltage level) to indicate that the overvoltage limit event is detected. In this way, the overvoltage monitor circuit 130-2 continually monitors the output voltage 220, detects whether the overvoltage limit event occurred, and generates the overvoltage limit signal 316-2 to indicate whether or not the overvoltage limit event is detected.

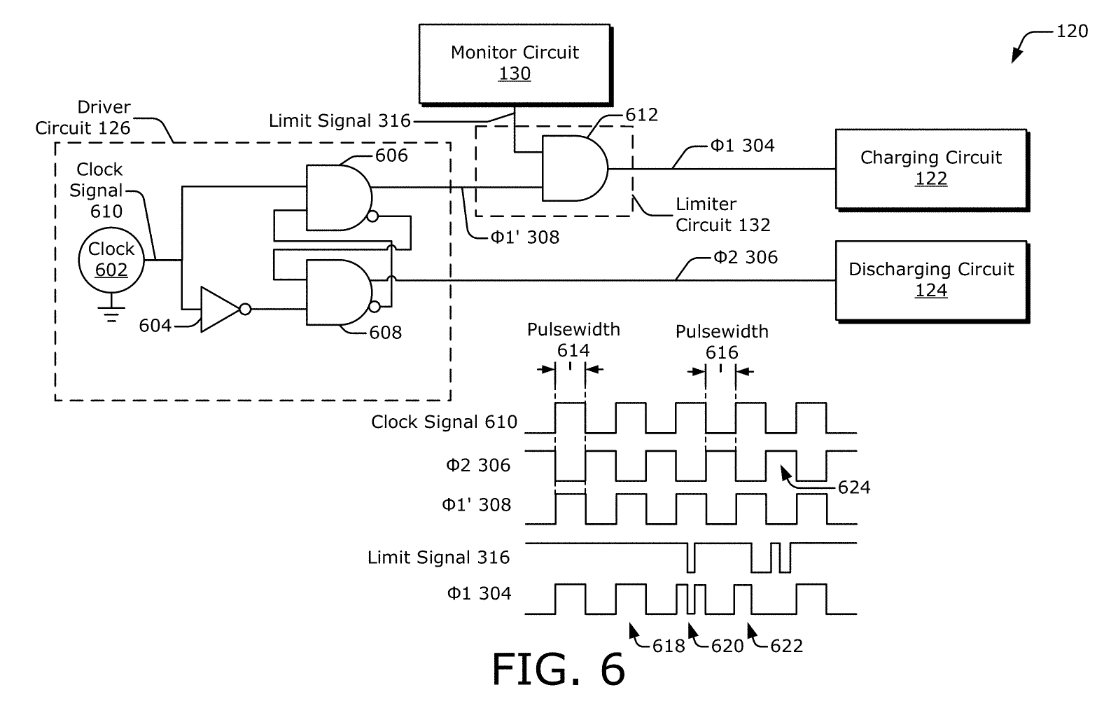

FIG. 6. illustrates an example driver circuit 126 and limiter circuit 132 for open-loop limiting of a charging phase pulsewidth. The driver circuit 126 includes a clock 602, at least one inverter 604, a first combinational logic circuit 606, and a second combinational logic circuit 608. The clock 602 is coupled to the first combinational logic circuit 606 and the inverter 604. The clock 602 generates a clock signal 610 having a pulsewidth and frequency that characterizes the intermediate charging phase signal 308 and the discharging phase signal 306. The first combinational logic circuit 606 performs an AND operation on the clock signal 610 and an inverse of the discharging phase signal 306 to generate the intermediate charging phase signal 308. The first combinational logic circuit 606 also generates an inverse of the intermediate charging phase signal 308, which is an input for the second combinational logic circuit 608. The second combinational logic circuit 608 performs another AND operation on an inverse of the clock signal and an inverse of the intermediate charging phase signal 308 to generate the discharging phase signal 306. The second combinational logic circuit 608 also generates an inverse of the discharging phase signal 306, which is an input for the first combinational logic circuit 606. Although not shown, the driver circuit 126 can also include buffers coupled between the first combinational logic circuit 606 and the second combinational logic circuit 608 to help decrease dead times associated with transitions between a high voltage level and a low voltage level of the intermediate charging phase signal 308 and the discharging phase signal 306 (e.g., dead times associated with switching between activation of the charging circuit 122 and the discharging circuit 124).

The limiter circuit 132 is implemented using an AND logic gate 612, which has a first input coupled to the first combinational logic circuit 606 and a second input coupled to the monitor circuit 130. The limiter circuit 132 performs an AND operation on the intermediate charging phase signal 308 and the limit signal 316 to generate the charging phase signal 304. In this way, the limiter circuit 132 limits a pulsewidth of the charging phase signal 304 without changing a pulsewidth of the discharging phase signal 306. The limiter circuit 132 can also be integrated within the driver circuit 126. For example, the first combinational logic circuit 606 can have a third input coupled to the monitor circuit 130 such that the first combinational logic circuit 606 generates the charging phase signal 304 by performing an AND operation on the clock signal 610, the inverse of the discharging phase signal 306, and the limit signal 316. In some embodiments, the limit signal 316 includes more than one signal, such as the overcurrent limit signal 316-1 and the overvoltage limit signal 316-2 of FIG. 5. In this case, the AND logic gate 612 or the first combinational logic circuit 606 can have a respective input associated with each limit signal 316.

Example signals are illustrated in FIG. 6 to demonstrate open-loop limiting of the charging phase signal 304 and show the relationship between the clock signal 610, the discharging phase signal 306, the intermediate charging phase signal 308, the limit signal 316, and the charging phase signal 304 over time. For illustration purposes, a duration of the limit signal 316 and a pulsewidth of the clock signal 610 are not drawn to scale. Additionally, for simplicity, transitions between voltage levels are shown to be instantaneous.

As shown, the clock signal 610 has approximately a 50% duty cycle; therefore, a pulsewidth 614 of the intermediate charging phase signal 308 is approximately equal to a pulsewidth 616 of the discharging phase signal 306. Example pulsewidths are typically on the order of microseconds (μs), such as 0.5 μs. These techniques, however, can be applied for a variety of different duty cycles and pulsewidths.

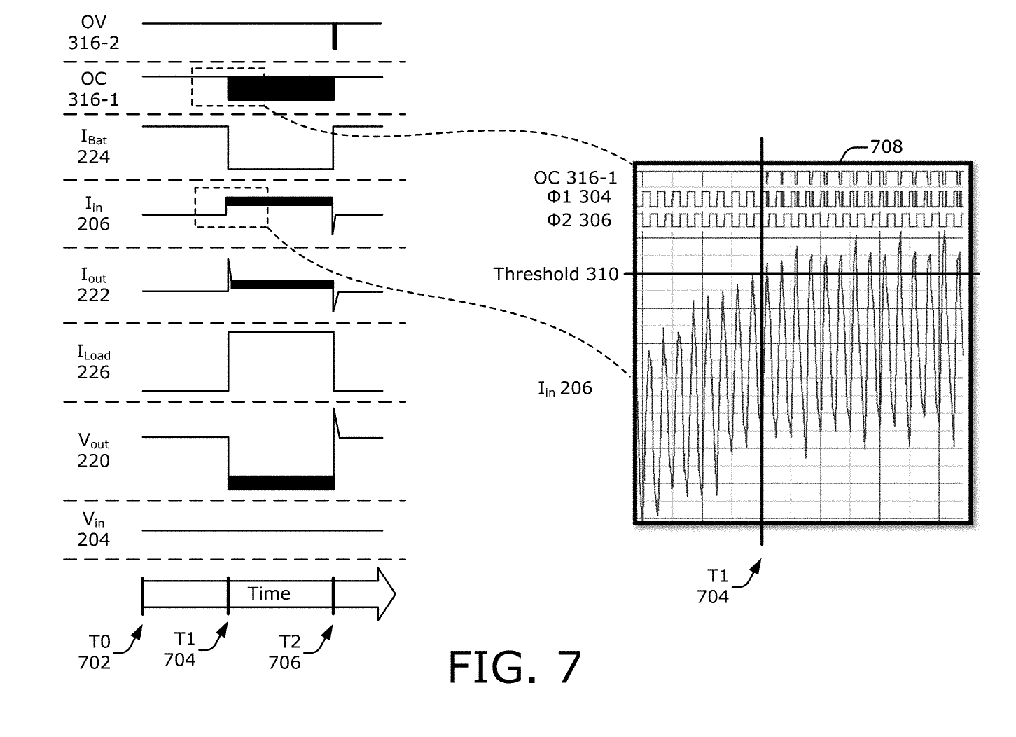

As described with respect to FIG. 5, the limit signal 316 has a high voltage level that indicates a limit event was not detected by the monitor circuit 130 and a low voltage level that indicates a limit event was detected. At 618, a limit event is not detected, therefore the charging phase signal 304 has a pulsewidth approximately equal to the pulsewidth 614 of the intermediate charging phase signal 308 or the clock signal 610. At 620, a limit event is detected while the intermediate charging phase signal 308 is high. The limiter circuit 132 thus limits the pulsewidth of the charging phase signal 304 (e.g., reduces the pulsewidth with respect to the intermediate charging phase signal 308 or the clock 602). In this case, a duration of the limit event is less than the pulsewidth 614 of the intermediate charging phase signal 308. Therefore, when the limit event is no longer detected and the limit signal 316 transitions from low to high, the charging phase signal 304 also transitions from low to high. Another example of pulsewidth limiting is shown at 622. Due to the duration of the limit event, the limit signal 316 limits the pulsewidth of the charging phase signal 304 for a remaining duration of the pulse. Although not explicitly shown, if a limit event occurs throughout a duration of the pulse, the pulse of the charging phase signal 304 is effectively skipped. Another example at 624 illustrates that detection of the limit event does not affect the pulsewidth of the discharging phase signal 306, even if the limit event occurs while the discharging phase signal 306 is high. Thus, discharging of the flying capacitor 402 continues to occur during the limit event based on the discharging phase signal 306. An example scenario in which load transients cause the monitor circuit 130 to detect a limit event is described with respect to FIG. 7.

FIG. 7 illustrates example signal responses associated with open-loop limiting of a charging phase pulsewidth. For illustration purposes, the depicted signals are not drawn to scale and fast variations in a signal are represented using thick line portions. During the depicted time period, assume that the charge pump switch 208 and the battery switch 210 are closed such that the main charger 118 enables the charge pump 120 to charge the battery 104.

At time TO 702, the variable voltage adapter 114 generates the input voltage 204 and the input current 206 based on the input control signal 230 provided by the main charger 118. During the depicted time period, the input voltage 204 remains relatively constant because any actions taken by the main charger 118 to vary the input voltage 204 takes more time than what is shown. Based on the input voltage 204 and the input current 206, the charge pump 120 produces the output voltage 220 and the output current 222 by charging and discharging the flying capacitor 402 via the charging circuit 122 and the discharging circuit 124. At this time, no limit events are detected and the overcurrent limit signal 316-1 and the overvoltage limit signal 316-2 are high. A portion of the output current 222 charges the battery 104 via the battery current 224 and another portion of the output current 222 goes to the system load 202 via the load current 226. Between time TO 702 and time T1 704, the system load 202 is constant such that the load current 226 does not significantly change. For this example, assume that the system load 202 is inactive and the load current 226 is approximately zero amperes.

At time T1 704, a load transient occurs as the system load 202 activates and the load current 226 increases. The larger load current 226 causes the input current 206 to increase. Between time T1 704 and time T2 706, the input current 206 exceeds the threshold 310, thus triggering detection of the overcurrent limit event by the overcurrent monitor circuit 130-1. A zoomed in plot of the overcurrent limit signal 316-1, the charging phase signal 304, the discharging phase signal 306, and the input current 206 is shown at 708. After time T1 704, the input current 206 exceeds the threshold 310 and causes the overcurrent monitor circuit 130-1 to set the overcurrent limit signal 316-1 low. In response, the limiter circuit 132 limits the pulsewidth of the charging phase signal 304. By limiting the pulsewidth, the limiter circuit 132 increases a time period the flying capacitor 402 is disconnected from the input node 212 (e.g., or decreases a time period the flying capacitor 402 is connected to the input node 212). In this manner, the limiter circuit 132 constrains the input current 206 and provides protection during the charging process. As shown in 708, the constraint causes the input current 206 to have an upper limit near the threshold 310. Accordingly, the threshold 310 can be set to achieve a desired protection, such as to protect against the input current 206 exceeding the maximum current rating of the power cable 116. Note that the pulsewidth of the discharging phase signal 306 is independent of the overcurrent limit signal 316-1.

At time T2 706, another load transient occurs as the system load 202 releases and the load current 226 decreases. The decrease in the load current 226 causes the output voltage 220 to increase beyond another threshold 310, such as an overvoltage threshold. This results in the overvoltage monitor circuit 130-2 setting the overvoltage limit signal 316-2 low, thereby causing the limiter circuit 132 to limit the pulsewidth of the charging phase signal 304. Similarly, limiting the pulsewidth of the charging phase signal 304 constrains the output voltage 220 and can protect against the output voltage 220 exceeding the maximum voltage rating of the battery 104.

The open-loop design of the open-loop charging phase pulsewidth limiter 128 enables fast response to load transients. Response times are on the order of microseconds, such as less than approximately 0.5 μs. This is advantageous as the time it takes for the main charger 118 to adjust the input voltage 204 can be on the order of milliseconds. Furthermore, instead of regulating the output voltage 220 or the input current 206, the open-loop charging phase pulsewidth limiter 128 constrains these values by reducing a time period that the flying capacitor is connected to the input node.

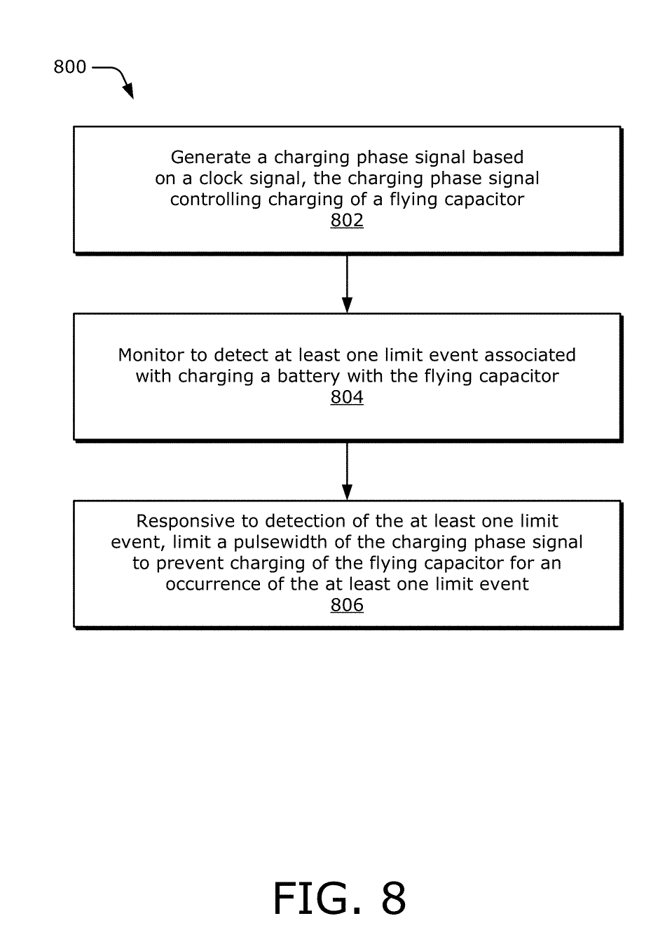

FIG. 8 is a flow diagram illustrating an example process 800 for open-loop limiting of a charging phase pulsewidth. The process 800 is described in the form of a set of blocks 802-806 that specify operations that can be performed. However, operations are not necessarily limited to the order shown in FIG. 8 or described herein, for the operations may be implemented in alternative orders or in fully or partially overlapping manners. Operations represented by the illustrated blocks of the process 800 may be performed by a battery charging system 108 (e.g., of FIG. 1 or 2) or a charge pump 120 (e.g., of FIGS. 1-3). More specifically, the operations of the process 800 may be performed by a driver circuit 126 and an open-loop charging phase pulsewidth limiter 128 as shown in FIGS. 5 and 6.

At block 802, a charging phase signal is generated based on a clock signal. The charging phase signal controls charging of a flying capacitor. For example, the driver circuit 126 can generate the intermediate charging phase signal 308 based on the clock signal 610, and the limiter circuit 132 can generate the charging phase signal 304 based on the intermediate charging phase signal 308. Based on the charging phase signal 304, the charging circuit 122 opens or closes the first switch 408, which is coupled between the flying capacitor 402 and the input node 212. By opening or closing the first switch 408, the charging circuit 122 controls charging of the flying capacitor 402.

At block 804, monitoring is performed to detect at least one limit event associated with charging a battery with the flying capacitor. For example, the monitor circuit 130 can include sensor circuitry 312 and comparator circuitry 314 to monitor for an occurrence of the limit event. This monitoring may be performed by the overcurrent monitor circuit 130-1 to detect an overcurrent limit event at the input node 212 or by the overvoltage monitor circuit 130-2 to detect an overvoltage limit event at the output node 214. In general, the limit event occurs when a current or a voltage exceeds the threshold 310.

At block 806, responsive to detection of the at least one limit event, a pulsewidth of the charging phase signal is limited to prevent charging of the flying capacitor during an occurrence of the at least one limit event. For example, the limiter circuit 132 can include an AND logic gate that limits the pulsewidth of the charging phase signal 304 based on the limit signal 316, which indicates whether the at least one limit event is detected. Limiting the pulsewidth causes the charging circuit 122 to open the first switch 408, thereby preventing charging of the flying capacitor 402 for the at least one limit event.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

1. An apparatus comprising:
an input node;
an output node coupled to a battery;
a flying capacitor coupled to the output node;
a driver circuit configured to generate a charging phase signal based on a clock signal, the charging phase signal having a pulsewidth;
a charging circuit having at least one switch, the at least one switch coupled between the input node and the flying capacitor, the charging circuit configured to connect or disconnect, based on the charging phase signal, the flying capacitor to or from the input node via the at least one switch; and
an open-loop charging phase pulsewidth limiter coupled to the driver circuit and the charging circuit, the open-loop charging phase pulsewidth limiter configured to:
monitor for at least one limit event associated with charging the battery with the flying capacitor; and
responsive to detection of the at least one limit event, limit the pulsewidth of the charging phase signal to a non-zero value to decrease a time period the flying capacitor is connected to the input node.

2. The apparatus of claim 1, wherein:
the open-loop charging phase pulsewidth limiter is coupled to the input node;
the at least one limit event includes an overcurrent limit event; and
the open-loop charging phase pulsewidth limiter is configured to:
determine a magnitude of an input current at the input node; and
detect the overcurrent limit event based on the magnitude exceeding an input current threshold.

3. The apparatus of claim 2, wherein:
the input node is configured to be coupled to a power cable having a maximum current rating;
the input current threshold is based on the maximum current rating of the power cable; and
the open-loop charging phase pulsewidth limiter configured to limit the pulsewidth of the charging phase signal to constrain the input current based on the maximum current rating.

4. The apparatus of claim 3, wherein:
the input node is configured to be coupled to a power source via the power cable and a variable voltage adapter; and
a response time associated with the open-loop charging phase pulsewidth limiter limiting the pulsewidth is shorter than a time period associated with adjusting the input current via the variable voltage adapter.

5. The apparatus of claim 4, wherein the response time is less than approximately 0.5 microseconds.

6. The apparatus of claim 1, wherein:
the open-loop charging phase pulsewidth limiter is coupled to the output node;
the at least one limit event includes an overvoltage limit event; and
the open-loop charging phase pulsewidth limiter is configured to:
determine a magnitude of an output voltage at the output node; and
detect the overvoltage limit event based on the magnitude exceeding an output voltage threshold.

7. The apparatus of claim 6, wherein:
the output voltage threshold is based on a maximum voltage rating of the battery; and
the open-loop charging phase pulsewidth limiter is configured to limit the pulsewidth of the charging phase signal to constrain the output voltage based on the maximum voltage rating.

8. The apparatus of claim 1, further comprising:
a discharging circuit having at least one other switch, the other switch coupled between a ground and the flying capacitor, wherein:
the driver circuit is configured to generate a discharging phase signal based on the clock signal, the discharging phase signal having another pulsewidth, the other pulsewidth being substantially independent of the detection of the at least one limit event; and
the discharging circuit is configured to connect or disconnect, based on the discharging phase signal, the flying capacitor to or from the ground via the other switch.

9. The apparatus of claim 1, wherein the charging circuit is configured to generate an output voltage at the output node that is approximately half an input voltage at the input node.

10. The apparatus of claim 1, wherein:
the open-loop charging phase pulsewidth limiter is configured to generate at least one limit signal that indicates whether the at least one limit event is detected based on the monitoring; and
the open-loop charging phase pulsewidth limiter is configured to limit the pulsewidth of the charging phase signal by performing an AND-operation on the charging phase signal generated by the driver circuit and the at least one limit signal.

11. The apparatus of claim 1, further comprising a charge pump including the flying capacitor, the driver circuit, and the open-loop charging phase pulsewidth limiter.

12. An apparatus comprising:
an input node;
an output node coupled to a battery;
a flying capacitor coupled to the output node;
a driver circuit configured to generate a charging phase signal based on a clock signal, the charging phase signal having a pulsewidth;
a charging circuit having at least one switch, the at least one switch coupled between the input node and the flying capacitor, the charging circuit configured to connect or disconnect, based on the charging phase signal, the flying capacitor to or from the input node via the at least one switch;
monitor means for detecting at least one limit event associated with charging the battery with the flying capacitor; and
limit means for limiting the pulsewidth of the charging phase signal to a non-zero value to decrease a time period the flying capacitor is connected to the input node, the limit means coupled to the driver circuit and the charging circuit.

13. The apparatus of claim 12, wherein the monitor means comprises:
sensor means for sensing a voltage or a current; and
comparison means for comparing the voltage or the current to a threshold.

14. The apparatus of claim 13, wherein the threshold comprises a programmable threshold.

15. The apparatus of claim 13, wherein:
the voltage comprises an output voltage;
the threshold comprises an output voltage threshold;
the sensor means senses the output voltage at the output node;
the comparison means compares the output voltage to the output voltage threshold; and
the at least one limit event includes an overvoltage limit event.

16. The apparatus of claim 13, wherein:
the current comprises an input current;
the threshold comprises an input current threshold;
the sensor means senses the input current at the input node;
the comparison means compares the input current to the input current threshold; and
the at least one limit event includes an overcurrent limit event.

17. The apparatus of claim 12, further comprising:
a discharging circuit having at least one other switch, the at least one other switch coupled between a ground and the flying capacitor, wherein:
the driver circuit is configured to generate a discharging phase signal based on the clock signal, the discharging phase signal having another pulsewidth, the other pulsewidth being substantially independent of a detection of the at least one limit event; and
the discharging circuit is configured to connect or disconnect, based on the discharging phase signal, the flying capacitor to or from the ground via the at least one other switch.

18. The apparatus of claim 12, wherein the charging circuit is configured to generate an output current at the output node that is approximately twice an input current at the input node.

19. The apparatus of claim 12, further comprising a charge pump including the flying capacitor, the driver circuit, the charging circuit, the monitor means, and the limit means.

20. A method for open-loop limiting of a charging phase pulsewidth, the method comprising:
generating a charging phase signal based on a clock signal, the charging phase signal controlling charging of a flying capacitor;
monitoring to detect at least one limit event associated with charging a battery with the flying capacitor; and
responsive to detection of the at least one limit event, limiting a pulsewidth of the charging phase signal to a non-zero value to prevent charging of the flying capacitor for an occurrence of the at least one limit event.

21. The method of claim 20, wherein:
the at least one limit event includes an overcurrent limit event associated with an input current used to charge the flying capacitor; and
the limiting of the pulsewidth of the charging phase signal comprises constraining the input current responsive to the input current exceeding an input current threshold.

22. The method of claim 20, wherein:
the at least one limit event includes an overvoltage limit event; and
the limiting of the pulsewidth of the charging phase signal comprises constraining an output voltage provided at the battery responsive to the output voltage exceeding an output voltage threshold.

23. The method of claim 20, further comprising generating a discharging phase signal based on the clock signal, the discharging phase signal controlling discharging of the flying capacitor for transferring charge from the flying capacitor to the battery, the discharging phase signal having another pulsewidth that is substantially independent of the detection of the at least one limit event.

24. An apparatus comprising:
a battery;
a charge pump including an input node, an output node, a switch, and a flying capacitor, the output node coupled between the flying capacitor and the battery, the switch coupled between the input node and the flying capacitor, the charge pump configured to:
generate, based on a clock signal, a charging phase signal to control opening and closing of the switch, the charging phase signal having a pulsewidth that sets a time period for closing the switch;
monitor the input node and the output node for at least one limit event, the at least one limit event associated with charging the battery with the flying capacitor; and
responsive to detection of the at least one limit event, limit the pulsewidth of the charging phase signal to a non-zero value to cause the charging phase signal to close the switch for the at least one limit event.

25. The apparatus of claim 24, wherein:
the charge pump includes another switch coupled between the flying capacitor and a ground; and
the charge pump is configured to:
generate, based on the clock signal, a discharging phase signal to control opening and closing of the other switch, the discharging phase signal having another pulsewidth that sets a time period for closing the other switch, the other pulsewidth being independent of the detection of the at least one limit event.

26. The apparatus of claim 24, further comprising a transient load coupled to the output node, wherein:
the at least one limit event includes an overcurrent limit event associated with the transient load causing an input current at the input node to increase above an input current threshold; and
the at least one limit event includes an overvoltage limit event associated with the transient load causing an output voltage at the output node to increase above an output voltage threshold.

27. The apparatus of claim 24, further comprising:
a variable voltage adapter configured to be coupled to a power source, the variable voltage adapter configured to generate an input voltage based on the power source;
a power cable coupled to the variable voltage adapter; and
a main charger having another switch coupled between the power cable and the input node of the charge pump, the main charger configured to:
control, via the other switch, charging of the battery via the charge pump; and
set the input voltage generated by the variable voltage adapter.

28. The apparatus of claim 27, wherein the main charger is coupled to the variable voltage adapter, the main charger configured to send an input control signal to the variable voltage adapter to set the input voltage.

29. The apparatus of claim 28, wherein the main charger is configured to send the input control signal via a universal serial bus (USB) interface.

30. The apparatus of claim 24, wherein the charge pump has a conversion ratio of two to one.
